(19) United States
(12) Patent Application Publication
(10) Pub. No.: US 2007/0236089 A1
(43) Pub. Date: Oct. 11, 2007

(54) Solenoid and pump using the same

(75) Inventor: Masashi Okubo, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/783,068

(22) Filed: Apr. 5, 2007

(30) Foreign Application Priority Data
Apr. 6, 2006 (JP) 2006-105653

(51) Int. Cl. H02K 41/00; H02K 7/06; H02K 33/00; H01F 7/08

(52) U.S. Cl. 310/30; 310/14; 335/220; 417/417; 310/23; 417/416

(57) ABSTRACT

The solenoid is capable of generating great thrust and having broad-ranging thrust characteristics. The solenoid of the present invention comprises: a guide pipe formed into a cylindrical shape and provided inside of an excitation coil; a movable element having a small diameter section and a large diameter section; a first yoke part covering one end face of the excitation coil, the first yoke part having a first facing surface, which faces an outer circumferential face of the small diameter section of the movable element, and a second facing surface, which faces one end face of the small diameter section; and a second yoke part covering the other end face of the excitation coil, the second yoke part having a third facing surface, which faces an outer circumferential face of the large diameter section of the movable element, and a fourth facing surface, which faces one end face of the large diameter section.

### BACKGROUND OF THE INVENTION

The present invention relates to a solenoid used as an actuator and a pump using the solenoid.

A conventional known solenoid is shown in FIG. 7.

The solenoid 10 comprises: an excitation coil 12; a yoke 14 encasing the excitation coil 12; a guide pipe 15 provided at the center of the excitation coil 12; and a movable element 16, e.g., a movable iron core, a plunger, slidably held in the guide pipe 15. The yoke 14 is constituted by an upper yoke part 14a, which is provided on one side of the excitation coil 12, and a lower yoke part 14b, which is provided on the other side of the excitation coil 12 (see Japanese Patent Gazettes No. 2000-277327 and No. 2005-291244).

In the solenoid 10 disclosed in the Japanese Patent Gazettes, the upper yoke part 14a has a facing surface 20, which faces one end face 16a of the movable element 16, and a facing surface 21, which faces an outer circumferential face 16b close to the one end face 16a of the movable element 16.

With this structure, facing areas of the yoke 14 and the movable element 16 are increased, so that permeance of a magnetic circuit can be increased and great thrust can be gained.

Further, the movable element 16 has a large diameter section 18, which is formed at the other end so as to cover the other end of the excitation coil 12, and thrust is generated between the large diameter section 16 and the lower yoke part 14b (see Japanese Patent Gazettes No. 7-263222 and No. 2003-338408).

The thrust of the movable element of the solenoid is highly influenced by the permeance of the magnetic circuit formed between the yoke and the movable element. The permeance is in proportion to a sectional area of a magnetic path and in reverse proportion to a gap (clearance) formed in the magnetic path. Thus, facing areas of the yoke and the movable element should be made larger, and a distance between the yoke and the movable element should be made shorter.

In the solenoid disclosed in the Japanese Patent Gazette No. 2000-277327 or No. 2005-291244, the gaps between the yoke and the one end part of the movable element, i.e., the one end face and the outer circumferential face close thereto, mainly contribute to the thrust generation. On the other hand, the other end part of the movable element does not contribute to the thrust generation. If the other end part of the movable element contributes to the thrust generation, the thrust can be further increased.

As disclosed in the Japanese Patent Gazettes No. 7-263222 and No. 2003-338408, the large diameter section is formed at the other end of the movable element, so that thrust can be generated in the gap between the one end face of the large diameter section and the above described problem can be solved. However, the thrust cannot be highly increased when the large diameter section is distantly moved away from the yoke. Therefore, a wide thrust generation range cannot be always gained.

As described above, the gap between the movable element and the yoke must be smaller so as to increase the permeance.

However, in the conventional solenoid, the coil wire of the excitation coil is wound on a coil bobbin, and the movable element is inserted in a hollow space of the coil bobbin so as to use the coil bobbin as the guide pipe.

In some cases, the coil bobbin is deformed when the coil wires is wound thereon. Therefore, an inner diameter of the coil bobbin must be previously made relatively large with respect to an outer diameter of the movable element. If the inner diameter of the coil bobbin is previously made large, concentricity of the movable element and the hollow space (the coil bobbin) must be lower. To solve this problem, the gap between the yoke and the movable element must be previously made large. Therefore, the permeance cannot be increased, and great thrust cannot be gained.

### SUMMARY OF THE INVENTION

The present invention was conceived to solve the above described problems.

An object of the present invention is to provide a solenoid capable of generating great thrust and having broad-ranging thrust characteristics.

Another object is to provide a pump, which includes said solenoid so as to have a superior pumping ability.

To achieve the objects, the present invention has the following structures.

Namely, the solenoid of the present invention comprises:

an excitation coil;

a guide pipe being formed into a cylindrical shape and provided inside of the excitation coil;

a movable element having a small diameter section, which is inserted in the guide pipe, and a large diameter section, which is located outside of the guide pipe;

a first yoke part covering one end face of the excitation coil, the first yoke part having a first facing surface, which faces an outer circumferential face of the small diameter section of the movable element, and a second facing surface, which faces one end face of the small diameter section; and

a second yoke part covering the other end face of the excitation coil so as to magnetically connect with the first yoke part, the second yoke part having a third facing surface, which faces an outer circumferential face of the large diameter section of the movable element, and a fourth facing surface, which faces one end face of the large diameter section.

With this structure, the thrust can be generated between the one end face of the movable element and the outer circumferential face thereof, which are included in one end part of the movable element, and the first yoke part. Further, the one end face of the large diameter section and the outer circumferential face thereof, which are included in the other end part of the movable element, face the yoke. Therefore, the outer circumferential face of the large diameter section, which is located at an outermost position with respect to the guide pipe, faces the third facing surface of the second yoke part, so that a stable thrust generation range can be extended, broad-ranging thrust characteristics can be gained and controllability can be improved.

In the solenoid, the excitation coil may be previously wound and put on an outer circumferential face of the guide pipe. With this structure, the solenoid can be assembled by attaching the excitation coil, which has been previously formed, to cover the guide pipe. Deformation of the guide pipe, which is caused by winding a coil wire on the guide pipe and shaping the coil, can be prevented, and a clearance between an inner diameter of the guide pipe and an outer diameter of the small diameter section of the movable element can be previously minimized. Therefore, the gaps between the facing surfaces of the second yoke part and the small diameter section of the movable element and the gaps between the facing surfaces of the second yoke part and the large diameter section of the movable element can be highly narrowed, and permeance therebetween can be increased so that great thrust can be gained.

In the solenoid, the guide pipe may be made of synthetic resin, and the guide pipe is integrally molded with the excitation coil. With this structure, the excitation coil is previously wound and shaped, and then the guide pipe is integrally molded with the shaped excitation coil. The deformation of the guide pipe, which is caused by winding the coil wire on the guide pipe and shaping the coil, can be prevented, and the clearance between the inner diameter of the guide pipe and the outer diameter of the small diameter section of the movable element can be previously minimized. Therefore, the gaps between the facing surfaces of the second yoke part and the small diameter section of the movable element and the gaps between the facing surfaces of the second yoke part and the large diameter section of the movable element can be highly narrowed, and the permeance therebetween can be increased so that great thrust can be gained.

In the solenoid, the guide pipe may be made of synthetic resin, and the guide pipe may be insert-molded or outsert-molded with at least one of the first yoke part and the second yoke part. With this structure, the yoke parts can be assembled on the basis of the guide pipe, which is capable of minimizing the clearance between the guide pipe and the small diameter section of the movable element, as a datum point. Therefore, the gaps between the facing surfaces of the yoke parts and the movable element can be accurately set, so that the permeance therebetween can be increased and great thrust can be gained.

In the solenoid, a concave section may be formed in the other end face of the large diameter section of said movable element and caved toward the one end face thereof. With this structure, weight of the part of the movable element, in which the concave section, can be reduced, so that the thrust can be further increased.

In the solenoid, an inner face of the concave section may be formed into a female tapered face, whose inner diameter is gradually reduced toward the inner end thereof. With this structure, the outer circumferential face of the large diameter section and the third facing surface of the second yoke part constitute a magnetic path. If a part of the large diameter section close to the small diameter section is made thinner by forming the concave section, magnetic saturation occurs, so that great magnetic flux cannot be generated between the movable element and the yoke. Thus, by gradually reducing the inner diameter of the concave section toward the inner end, the part of the large diameter section facing the third facing surface of the second yoke part is made gradually thicker toward the other end side, so that the magnetic saturation is restrained and great thrust can be gained.

Further, the pump of the present invention comprises:

the solenoid of the present invention;

a diaphragm being provided to one end of said movable element;

a diaphragm chamber, whose cubic volume is varied by action of the diaphragm; and

an inlet valve and an outlet valve being actuated by the variation of the cubic volume of the diaphragm chamber.

With this structure, the diaphragm can be actuated by the solenoid capable of generating great thrust, so that pumping ability of the pump can be highly improved.

### BRIEF DESCRIPTION OF THE DRAWINGS

Embodiments of the present invention will now be described by way of examples and with reference to the accompanying drawings, in which:

FIG. 1 is a sectional view of a solenoid of a first embodiment of the present invention;

FIG. 2 is a sectional view of a solenoid of a second embodiment of the present invention;

FIG. 3 is a sectional view of the solenoid shown in FIG. 2, wherein a movable element is projected toward the other side;

FIG. 4 is a sectional view of another example of the solenoid of the second embodiment;

FIG. 5 is a graph showing a thrust-displacement characteristic of the solenoid of the first embodiment;

FIG. 6 is a sectional view of a pump using the solenoid of the first embodiment; and

FIG. 7 is a sectional view of the conventional solenoid.

### DETAILED DESCRIPTION OF THE EMBODIMENTS

Preferred embodiments of the present invention will now be described in detail with reference to the accompanying drawings.

### First Embodiment

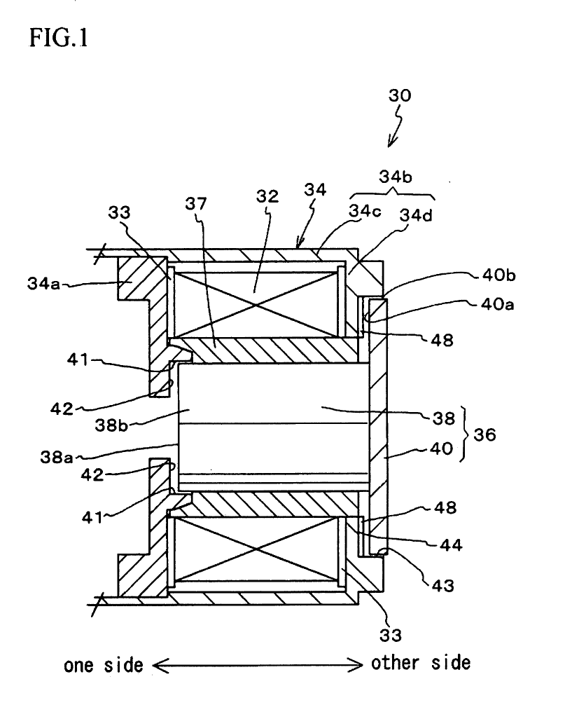

A solenoid of a first embodiment of the present invention will be explained with reference to FIG. 1.

A solenoid 30 has an excitation coil 32, a yoke 34 and a movable element 36. The movable element 36 is accommodated in a guide pipe 37. The guide pipe 37 is made of a nonmagnetic material, e.g., synthetic resin.

The yoke 34 is made of a magnetic material and encases the excitation coil 32. Insulating members 33 are provided between both ends of the excitation coil 32 and the yoke 34.

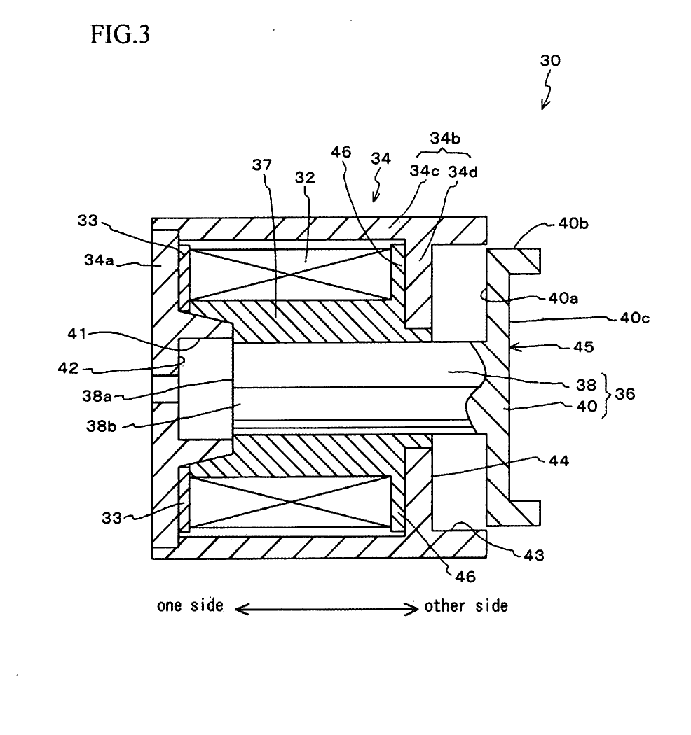

The yoke 34 comprises an upper yoke part 34a, which is provided on one side (on the left side in the FIG. 1 to FIG. 4) of the excitation coil 32, and a lower yoke part 34b, which is provided on the other side (on the right side in the FIG. 1 to FIG. 4) thereof.

Note that, the upper yoke part 34a acts as the first yoke part of the claims; the lower yoke part 34b acts as the second yoke part thereof. In the present embodiment, the lower yoke part 34b covers a side face of the excitation coil 32.

The movable element 36 is made of a magnetic material. The movable element 36 comprises a small diameter section 38 accommodated in the guide pipe 37 and a large diameter section 40 provided to an end of the small diameter section 38 located on the other side.

An outer diameter of the small diameter section 38 is slightly smaller than an inner diameter of the guide pipe 37. With this structure, the movable element 36 is capable of smoothly sliding in the guide pipe 37.

An outer diameter of the large diameter section 40 is larger than the inner diameter of the guide pipe 37. With this structure, the large diameter 40 is located outside of the guide pipe 37 without accommodating therein.

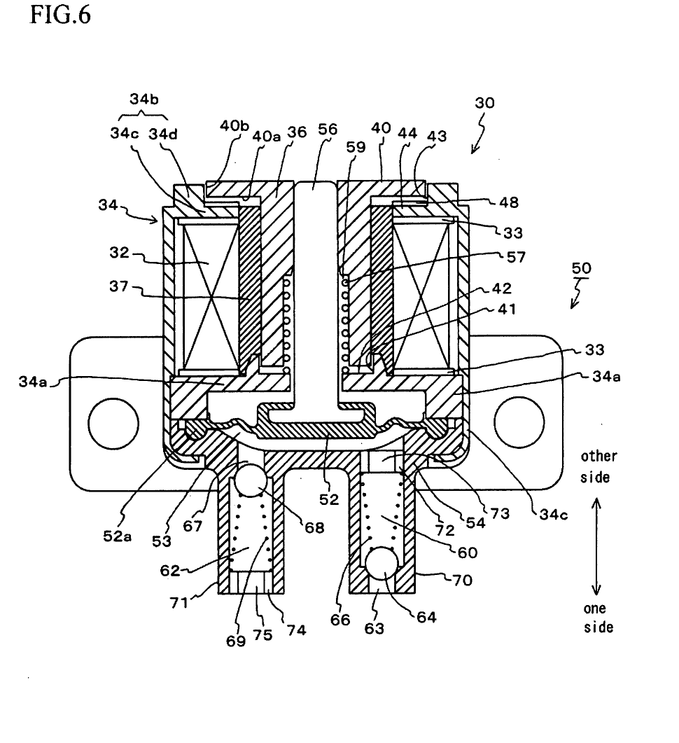

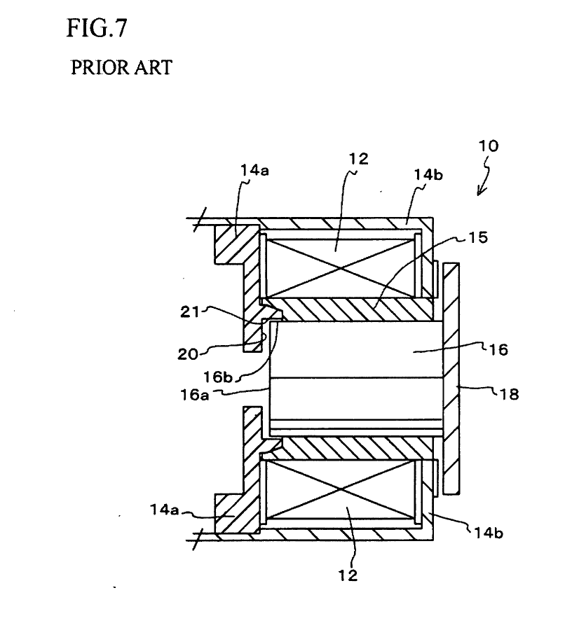

The movable element 36 is drawn by magnetic energy generated by the excitation coil 32. Note that, the movable element is biased outward by, for example, spring (see FIG. 6).

A second facing surface 42, which faces one end face 38a of the small diameter section 38 of the movable element 36, is formed at the center of the upper yoke part 34a. Further, a first facing surface 41 is formed in an extended section, which encloses the second facing surface 42 and which is perpendicularly extended toward the other side from the second facing surface 42. The first facing surface 41 faces an outer circumferential face 38b close to the one end face 38a of the small diameter section 38 of the movable element 36.

A magnetic path is formed between the movable element 36 and the first and second facing surfaces 41 and 42 of the upper yoke part 34a.

The lower yoke part 34b includes a side wall section 34c, which covers the side face of the excitation coil 32, and a facing section 34d, which covers the other end face of the excitation coil 32. The facing section 34d has a third facing surface 43, which faces an outer circumferential face 40b of the large diameter section 40, and a fourth facing surface 44, which faces an end face 40a of the large diameter section 40 located on the one side.

The third facing surface 43 is formed in an inner face of an extended section, which is perpendicularly extended toward the other side from the fourth facing surface 44.

The first and third facing surfaces 41 and 43 are respectively separated from the outer circumferential face 38b of the small diameter section 38 of the movable element 36 and the outer circumferential face 40b of the large diameter section 40 thereof by forming minute clearances.

Since the guide pipe 37 is integrally resin-molded with the excitation coil 32, in which a coil wire has been previously wounded, when the solenoid 30 is produced, the minute clearances can be formed between the facing surfaces 41 and 43 and the outer circumferential faces. Therefore, the excitation coil 32 is a ring-shaped molded coil. By employing the ring-shaped molded coil, deformation of the guide pipe 37, which is caused when the coil wire is directly wounded on the guide pipe 37, can be prevented, and the yoke parts 34a and 34b can be correctly assembled on the basis of the guide pipe 37 as a datum point.

In the present embodiment, the clearance between the first facing surface 41 of the movable element 36 and the outer circumferential face 38b of the small diameter section 38 and the clearance between the third facing surface 43 of the movable element 36 and the outer circumferential face 40b of the large diameter section 40 can be about 0.1 mm.

A rubber cushion 48 is provided to the facing section 34d of the lower yoke part 34b. When the movable element 36 is moved toward the one side, the end face 40a of the large diameter section 40 contacts the rubber cushion 48, so that vibration, which is caused by the contact of the large diameter section 40 and the lower yoke part 34b, can be prevented.

### Second Embodiment

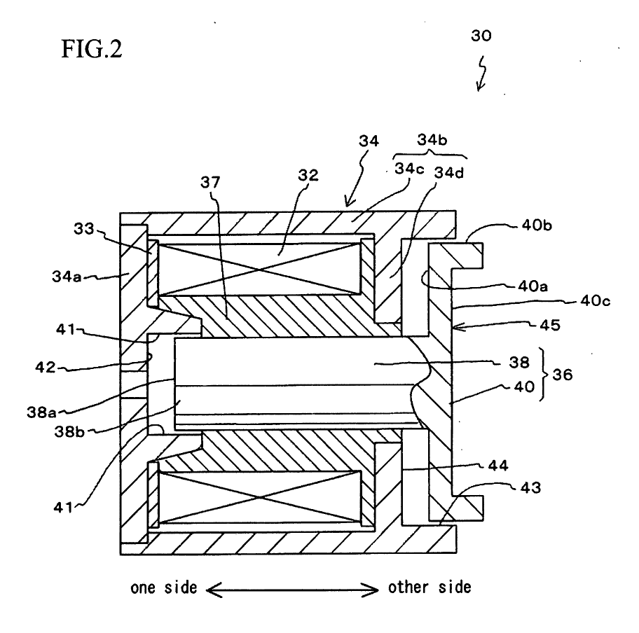

Next, the solenoid of a second embodiment will be explained with reference to FIGS. 2-4.

Note that, structural elements explained in the first embodiment are assigned the same symbols and explanation will be omitted.

In the present embodiment, a concave section 45 is formed in the end face 40c of the large diameter section 40 of the movable element 36 located on the other side and is caved toward the one side. By forming the concave section 45 in the end face 40c of the large diameter section 40 located on the other side, weight of the movable element 36 can be reduced without reducing a facing area of the outer circumferential face 40b of the large diameter section 40 with respect to the lower yoke part 34b.

By insert-molding or outsert-molding the guide pipe 37 with the upper yoke part 34a or the lower yoke part 34b, the upper yoke part 34a or the lower yoke part 34b can be suitably assembled thereto.

In an insert-molding process, the upper yoke part 34a or the lower yoke part 34b is set in a molding die for molding the guide pipe 37, and synthetic resin for forming the guide pipe 37 is injected into the molding die. On the other hand, in an outsert-molding process, the synthetic resin is injected onto the upper yoke part 34a or the lower yoke part 34b so as to form the guide pipe 37.

In each of the processes, concentricity of the guide pipe 37 and the upper yoke part 34a or the lower yoke part 34b can be improved, so that the clearances between the facing surfaces 41 and 43 and the movable element 36 can be minimized. Therefore, permeance can be increased, and great thrust can be generated.

In the present embodiment, the excitation coil 32 is formed by attaching and fixing a coil, which has been previously wound, and put on an outer circumferential face of the guide pipe 37.

Therefore, the deformation of the guide pipe 37, which is caused when the coil wire is directly wound on the guide pipe 37, can be prevented.

A flange 46 is radially extended outward from the guide pipe 37 so as to cover the end face of the excitation coil 32 on the other side. Since the flange 46 of the guide pipe 37 is provided between the other end face of the excitation coil 32 and the facing section 34d of the lower yoke part 34b, the excitation coil 32 can be electrically insulated from the lower yoke part 34b without providing an insulating member.

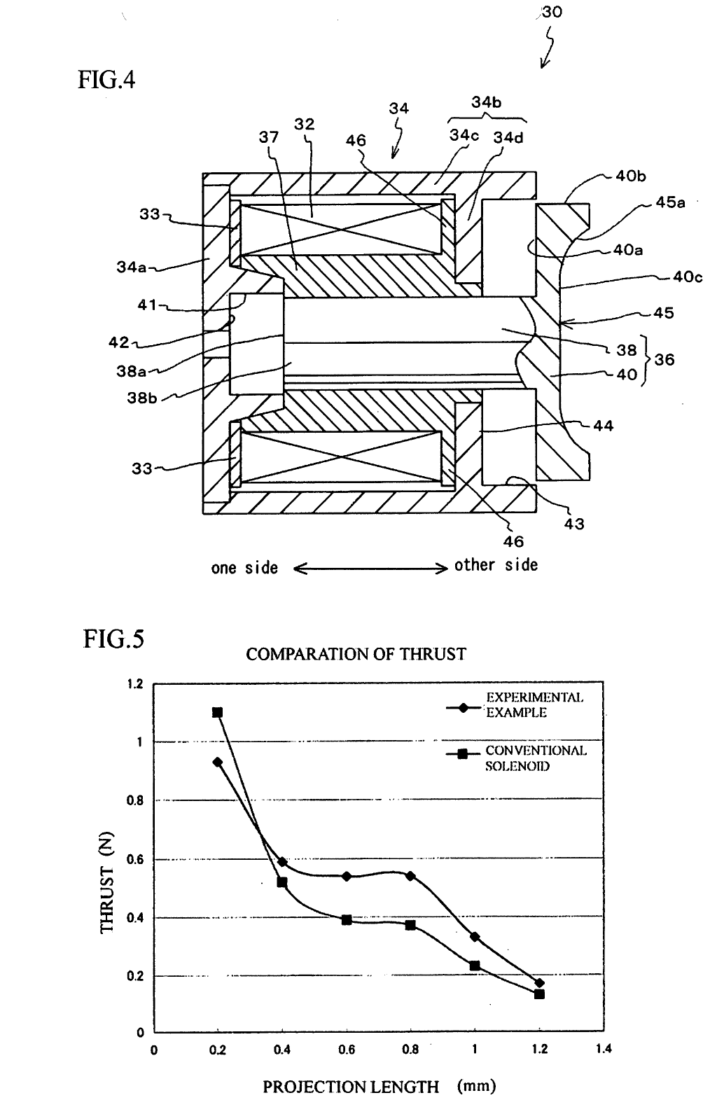

Note that, as shown in FIG. 4, an inner face 45a of the concave section 45 of the large diameter section 40 of the movable element 36 may be formed into a female tapered face, whose inner diameter is gradually reduced toward the inner end thereof. With this structure, a sectional area of a magnetic path from the outer circumferential face 40b of the large diameter section 40 to the small diameter section 38 is increased, so that the magnetic saturation is restrained and the magnetic path can be suitably formed.

In the present embodiment, the guide pipe 37 is insert-molded or outsert-molded with the lower yoke part 34b. In this case, the solenoid 30 is produced by the steps of: integrally molding the guide pipe 37 with the lower yoke part 34b; attaching the excitation coil 32, in which the coil wire has been previously wound, onto the outer circumferential face of the guide pipe 37; and attaching the upper yoke par 34a.

Note that, when the guide pipe 37 is molded, the guide pipe 37 may be integrally insert-molded or outsert-molded with all of the excitation coil 32, the upper yoke part 34a and the lower yoke part 34b.

### (Experimental Example)

The solenoid having the structure shown in FIG. 1 was produced as an experimental example. Thrust characteristics of the experimental example and a conventional solenoid, which has the large diameter section 40 and no surface facing the outer circumferential face 40b of the large diameter section 40, were measured. The results are shown in a graph of FIG. 5.

A horizontal axis of the graph indicates a projection length of the movable element moving toward the other side; a vertical axis thereof indicates thrust.

According to the graph, unlike the conventional solenoid, the solenoid of the experimental example was capable of generating great thrust within an entire stroke except when the movable element 36 is at a position closest to the one side.

Therefore, the thrust can be increased by forming the third facing surface 43, which faces the outer circumferential face 40b of the large diameter section 40, in the lower yoke part 34b.

### (Embodiment of Pump)

Next, the pump using the solenoid 30 will be explained with reference to FIG. 6.

The solenoid 30 is the solenoid of the first embodiment, so structural elements explained in the former embodiments are assigned the same symbols and explanation will be omitted.

In a pump 50, a diaphragm 52 is reciprocally moved by the movable element 36 of the solenoid 30 so as to vary cubic volume of a diaphragm chamber 53, so that fluid can be sucked and discharged. The diaphragm chamber 53 is a space formed between a side face of the diaphragm 52 on the one side (on the down side in the FIG. 6) and a side face of a pump cover 54 on the other side (on the up side in the FIG. 6).

A supporting rod 56 connected to the diaphragm 52 is provided at the center of the movable element 36 of the solenoid 30.

The supporting rod 56 is projected toward the other side from the solenoid 30 and fixed to the center of the diaphragm 52.

The movable element 36 of the solenoid 30 is biased toward the other side by a spring 57. The spring 57 is accommodated in a spring accommodating section 59 formed in the movable element 36 and covers the supporting rod 56. The spring 57 is compressed between an end of the spring accommodating section 59 on the other side and the second facing surface 42 of the upper yoke part 34a.

By passing an exciting current through the exciting coil 32, a magnetic circuit is formed, so that the movable element 36 is drawn toward the one side. When the exciting current passing through the exciting coil is turned off, the magnetic circuit is disappeared, so that the movable element 36 is moved in the opposite direction by elasticity of the spring 57.

By tuning on and off the exciting current passing through the exciting coil 32, the movable element 36 is reciprocally moved.

The pump cover 54 is provided to the end of the upper yoke part 34a of the solenoid 30 on the one side. The side wall section 34c of the lower yoke part 34b contacts outer circumferential faces of the pump cover 54 and the upper yoke part 34a. The front end of the side wall section 34c is bent along an end face of the pump cover 54 on the one side, so that the side wall sections 34c clamps the upper yoke part 34a and the pump cover 54.

An edge 52a of the diaphragm 52 is clamped between the end face of the upper yoke part 34a on the one side and the pump cover 54 for fixation.

The edge 52a of the diaphragm 52 is clamped and deformed between the upper yoke part 34a and the pump cover 54, so that a space formed therebetween can be sealed.

An inlet valve and an outlet valve, which are actuated by the reciprocating movement of the diaphragm 52, are provided to the pump cover 54. The inlet valve and the outlet valve are respectively provided in cylindrical sections 70 and 71, which are projected toward the one side from the pump cover 54.

A sucking hole 60, which connects the diaphragm chamber 53 to the outside of the pump, is formed in the cylindrical section 70 of the pump cover 54. A check ball 64, which contacts an inner edge of an outer opening 63 to be connected to an external member so as to close the sucking hole 60, is provided in the sucking hole 60. The check ball 64 acts as the inlet valve.

One end of a spring 66 contacts the check ball 64, so that the check ball 64 is biased to close the outer opening 63 by elasticity of the spring 66. The other end of the spring 66 contacts a snap ring 72, which holds the other end of the spring 66. The snap ring 72 has an inner opening 73, which connects the sucking hole 60 to the diaphragm chamber 53.

A discharging hole 62, which connects the diaphragm chamber 53 to the outside of the pump, is formed in the cylindrical section 71 of the pump cover 54. A check ball 68, which contacts an outer edge of an inner opening 67 contacted to the diaphragm chamber 53 so as to close the discharging hole 62, is provided in the discharging hole 62. The check ball 68 acts as the outlet valve.

One end of a spring 69 contacts the check ball 68, so that the check ball 68 is biased to close the inner opening 67 by elasticity of the spring 69. The other end of the spring 69 contacts a snap ring 74, which holds the other end of the spring 69. The snap ring 74 has an outer opening 75, which connects the discharging hole 62 to an external member.

An action of the pump 50 will be explained.

When the exciting current passes through the exciting coil 32, the movable element 36 is moved in the one direction against the elasticity of the spring 57 and presses the diaphragm 52, which is fixed to the front end of the supporting rod 56, in the one direction.

Then, a fluid in the diaphragm chamber 53 presses the check ball 68 in the discharging hole 62 against the elasticity of the spring 69, so that the inner opening 67 is opened and the fluid in the diaphragm chamber 53 is discharged outside via the discharging hole 62.

When the exciting current passing through the exciting coil 32 is turned off, the movable element 36 is moved in the opposite direction by the elasticity of the spring 57. Further, the diaphragm 52, which is fixed to the front end of the supporting rod 56, is also moved in the opposite direction.

Then, the cubic volume of the diaphragm chamber 53 is increased, so that the check ball 64 in the sucking hole 60 is drawn toward the diaphragm chamber 53 against the elasticity of the spring 66, so that the outer opening 63 is opened and the fluid flows into the diaphragm chamber 53 via the sucking hole 60.

As described above, the pump 50 can suitably suck and discharge the fluid by the reciprocating movement of the movable element 36 of the solenoid 30.

By employing the solenoid of the present invention, even if the pump is downsized, enough thrust and superior pumping ability can be gained by low electric power. The pump can be suitably applied to pumps for feeding air and fuel to fuel cells, pumps for medical devices, pumps for cooling notebook-size computers, etc.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A solenoid,
comprising:
an excitation coil;
a guide pipe being formed into a cylindrical shape and provided inside of said excitation coil;
a movable element having a small diameter section, which is inserted in said guide pipe, and a large diameter section, which is located outside of said guide pipe;
a first yoke part covering one end face of said excitation coil, said first yoke part having a first facing surface, which faces an outer circumferential face of the small diameter section of said movable element, and a second facing surface, which faces one end face of the small diameter section; and
a second yoke part covering the other end face of said excitation coil so as to magnetically connect with said first yoke part, said second yoke part having a third facing surface, which faces an outer circumferential face of the large diameter section of said movable element, and a fourth facing surface, which faces one end face of the large diameter section.

2. The solenoid according to claim 1,
wherein the excitation coil is previously wound and put on an outer circumferential face of said guide pipe.

3. The solenoid according to claim 1,
wherein said guide pipe is made of synthetic resin, and
said guide pipe is integrally molded with said excitation coil.

4. The solenoid according to claim 1,
wherein said guide pipe is made of synthetic resin, and
said guide pipe is insert-molded or outsert-molded with at least one of said first yoke part and said second yoke part.

5. The solenoid according to claim 2,
wherein said guide pipe is made of synthetic resin, and
said guide pipe is insert-molded or outsert-molded with at least one of said first yoke part and said second yoke part.

6. The solenoid according to claim 3,
wherein said guide pipe is made of synthetic resin, and
said guide pipe is insert-molded or outsert-molded with at least one of said first yoke part and said second yoke part.

7. The solenoid according to claim 1,
wherein a concave section is formed in the other end face of the large diameter section of said movable element and is caved toward the one end face thereof.

8. The solenoid according to claim 2,
wherein a concave section is formed in the other end face of the large diameter section of said movable element and is caved toward the one end face thereof.

9. The solenoid according to claim 3,
wherein a concave section is formed in the other end face of the large diameter section of said movable element and is caved toward the one end face thereof.

10. The solenoid according to claim 4,
wherein a concave section is formed in the other end face of the large diameter section of said movable element and is caved toward the one end face thereof.

11. The solenoid according to claim 5,
wherein a concave section is formed in the other end face of the large diameter section of said movable element and is caved toward the one end face thereof.

12. The solenoid according to claim 6,
wherein a concave section is formed in the other end face of the large diameter section of said movable element and is caved toward the one end face thereof.

13. The solenoid according to claim 7,
wherein an inner face of the concave section is formed into a female tapered face, whose inner diameter is gradually reduced toward the inner end thereof.

14. A pump,
comprising:
a solenoid including an excitation coil, a guide pipe being formed into a cylindrical shape and provided inside of the excitation coil, a movable element having a small diameter section, which is inserted in the guide pipe, and a large diameter section, which is located outside of the guide pipe, a first yoke part covering an end face of the excitation coil located on one side thereof, the first yoke part having a first facing surface, which faces an outer circumferential face of the small diameter section of the movable element, and a second facing surface, which faces an end face of the small diameter section located on the one side, and a second yoke part covering an end face of the excitation coil located on the other side thereof so as to magnetically connect with the first yoke part, the second yoke part having a third facing surface, which faces an outer circumferential face of the large diameter section of the movable element, and a fourth facing surface, which faces an end face of the large diameter section located on the one side;
a diaphragm being provided to one end of said movable element;
a diaphragm chamber, whose cubic volume is varied by action of said diaphragm; and
an inlet valve and an outlet valve being actuated by the variation of the cubic volume of said diaphragm chamber.
